(19) United States
(12) Patent Application Publication
(10) Pub. No.: US 2009/0270532 A1
(43) Pub. Date: Oct. 29, 2009

(54) Process for Production of Resin-Coated Heat Accumulator Particles

(76) Inventors: Masahiko Gotoh, Osaka (JP); Yasushi Nakata, Osaka (JP); Masayoshi Nomura, Kyoto (JP)

Correspondence Address: WENDEROTH, LIND & PONACK, L.L.P., 1030 15th Street, N.W.,, Suite 400 East, Washington, DC, 20005-1503, US

(21) Appl. No.: 12/225,695

(22) PCT Filed: Mar. 28, 2007
(86) PCT No.: PCT/JP2007/056708

§ 371 Date: Nov. 19, 2008

(30) Foreign Application Priority Data
Mar. 28, 2006 (JP) 2006-088263
Dec. 13, 2006 (JP) 2006-336327
Dec. 13, 2006 (JP) 2006-336328

(51) Int. Cl. C04B 24/24; C09K 3/00

(52) U.S. Cl. 523/201; 252/70

(57) ABSTRACT

The present invention provides a method of producing resin-coated latent heat storage particles which can be continuously supplied to a producing step of a water-curable-type inorganic material (gypsum, cement, and the like), with a latent heat storage component in the particles hard to volatilize.

The above-mentioned method is a method of producing particles comprising a step of dispersing a latent heat storage component, isocyanate, and porous particles in water under stirring condition, said particles comprising as core said latent heat storage component and as shell a resin.

### TECHNICAL FIELD

The present invention relates to a method of producing resin-coated latent heat storage particles which can be continuously supplied to a producing step of a water-curable-type inorganic material (gypsum, cement, and the like), with a latent heat storage component in the particles hard to volatilize.

### BACKGROUND ART

Recently, there have been employed: natural heat energy such as sunlight for residential heating; and cheaper nighttime electricity during off-peak hours of electrical demand for heating and cooling. It is important to keep heating and cooling effects once obtained as long as possible for further efficient heating and cooling as thus described. There also exists a need for an efficient use of once heated-up heat in an exhaust-gas reduction apparatus in vehicles and the like. Proposed for achieving these objects is a latent heat storage material including a latent heat storage component, and a phase transition of a latent heat storage component occurs depending on the temperature. Such a latent heat storage material has a property of absorbing and emitting heat upon a liquid-to-solid phase (and vice versa) transition.

Patent Documents 1 and 2 disclose latent heat storage microcapsules with a latent heat storage component such as wax encapsulated in a resin shell. Utilizing latent heat storage microcapsules obviates the concern of volatilization of the latent heat storage component and the like and allows for efficient production of a latent heat storage molding, etc. Addition of latent heat to sensible heat can lead to expectation of extremely high heat efficiency upon mixing such latent heat storage microcapsules into building materials such as a gypsum board, a concrete block, and a concrete molding.

Since such latent heat storage microcapsules, however, may involve leakage of the latent heat storage component upon production of a latent heat storage molding and the like and a thickened resin shell causes reduction in an amount of the latent heat storage component to be encapsulated, a latent heat storage property is deteriorated. Moreover, production of the latent heat storage microcapsules requires complicated steps such as suspension polymerization in a medium including the latent heat storage component, so that productivity and costs are not necessarily satisfactory.

On the other hand, Patent Documents 3 and 4 disclose a latent heat storage material in which a latent heat storage component such as a paraffin wax is supported on a porous material comprising silica and the like. Such a latent heat storage material can be easily produced by following relatively simple steps. Such a latent heat storage material, however, is prone to the problem of significant deterioration of a latent heat storage property, due to exudation of the latent heat storage component from the porous material upon liquefaction of the latent heat storage component and also to volatilization of the latent heat storage component with the passage of time.

### Patent Document 1: Japanese Patent No. 3496195

### Patent Document 2: Japanese Kohyo Publication 2002-516913

### Patent Document 3: Japanese Kokai Publication Hei-9-143461

### Patent Document 4: Japanese Kohyo Publication 2002-523719

### DISCLOSURE OF THE INVENTION

### Problems to be Solved by the Invention

In view of the above-mentioned present situations, it is an object of the present invention to provide a method of producing resin-coated latent heat storage particles which can be continuously supplied to a producing step of a water-curable-type inorganic material (gypsum, cement, and the like), with a latent heat storage component in the particles hard to volatilize.

### Means for Solving the Problems

The present invention 1 is a method of producing particles, comprising a step of dispersing a latent heat storage component, isocyanate, and porous particles in water under stirring condition, said particles comprising as core said latent heat storage component and as shell a resin.

The present invention 2 is a method of producing particles, comprising a step of dispersing a latent heat storage component, isocyanate, a polyfunctional alcohol, and porous particles in water under stirring condition, said particles comprising as core said latent heat storage component and as shell a resin.

The present invention 3 is a method of producing particles, comprising a step of dispersing a latent heat storage component, a modified silicone resin, a tin catalyst, and porous particles in water under stirring condition, said particles comprising as core said latent heat storage component and as shell a resin.

The present invention 4 is a method of producing particles, comprising a step of dispersing a latent heat storage component, an epoxy resin, an amine compound, and porous particles in water under stirring condition, said particles comprising as core said latent heat storage component and as shell a resin.

Hereinafter, the present invention will be described in detail.

The present inventors made an intensive investigation, and consequently found it possible to extremely and easily produce resin-coated latent heat storage particles, which show superior heat resistance and can inhibit volatilization of the latent heat storage component, because a latent heat storage component serves as core and a curable component serves as shell by dispersing in water under stirring condition: a predetermined latent heat storage component; isocyanate, isocyanate and a polyfunctional alcohol, a modified silicone resin and a tin catalyst, or an epoxy resin and an amine compound as a curable component; and porous particles. In the resin-coated latent heat storage particles obtained by the method of the present invention, since a shell is being formed by interfacial polycondensation of a curable-component composition, the particles will obtain strength high enough to endure stress to some extent within a very short time before completion of the reaction. Moreover, since the porous particles present on the surface of the resin-coated latent heat storage particles can supposedly prevent agglomeration between the resin-coated latent heat storage particles. The resin-coated latent heat storage particles are, furthermore, obtainable in a dispersed state in water. Therefore, the particles can be successively supplied to a mixing step with a water-curable inorganic material (such as gypsum and cement), and the like after production of the resin-coated latent heat storage particles. Also, water is efficiently used upon curing the inorganic material.

In the method of producing resin-coated latent heat storage particles of the present invention, by simultaneously dispersing a latent heat storage component and the like and porous particles in water under stirring condition, a shell is formed around the latent heat storage component by interfacial polycondensation of a curable-component composition, and at the same time the porous particles surround the shell. It is, therefore, possible to obtain monodispersed resin-coated latent heat storage particles, which have a suitable size and strength capable of enduring stress to some degree within a very short period of time without agglomeration between the resin-coated latent heat storage particles. That is, the resin-coated latent heat storage particles do not agglomerate even though the resin shell (resin as shell) is uncured, so that the resin-coated latent heat storage particles can be removed within a very short time (from a few seconds up to about 30 seconds) after dispersed under stirring condition to be supplied to the next step.

The latent heat storage component is not particularly limited, and examples thereof include: aliphatic hydrocarbons; aromatic hydrocarbons; fatty acids; alcohols; and the like. Upon use of the present invention as a residential heat insulator, organic compounds in which a phase transition occurs at around room temperature are preferably used, that is, aliphatic hydrocarbons which have a melting point of not less than 0° C. and less than 50° C., are preferably used, and specific examples thereof include pentadecane, hexadecane, heptadecane, octadecane, nonadecane, icosane, docosane, and the like.

In these aliphatic hydrocarbons, a melting point increases with an increase in the carbon number, so that it is possible to choose hydrocarbon which has a melting point suited to an object, and to use a mixture of two or more kinds of hydrocarbons. Also, carbon, metal powder, and the like may be added to the organic compound in order to adjust heat conductivity, specific gravity, etc. of the present invention.

The porous particles temporarily absorb the latent heat storage component and/or the curable component, and then, upon forming resin-coated latent heat storage particles, the porous particles present on the surface of the resin-coated latent heat storage particles presumably serve as a dispersant which prevents agglomeration between the resin-coated latent heat storage particles.

Various substances are generally known as a dispersant, and a general dispersant except for porous particles, such as carboxymethyl cellulose and polyethyleneimine, may be probably used. Using such a dispersant except for porous particles makes it possible to keep a particle shape while stress is applied by stirring and the like within a very short time range, that is, within 30 minutes after starting production of particles; however, it is impossible to keep the particle shape once the stress application is stopped, so that the particles cannot be supplied to the next step. Meanwhile, excellent effects of the present invention can be exerted only upon using the porous particles. The reason of this is uncertain but is presumably that the latent heat storage component and the curable component can form in much water an interfacial state necessary to form particles by adding the porous particles.

In the method of producing resin-coated latent heat storage particles of the present invention, the porous particles are preferably added into water before adding the latent heat storage component or the curable component thereinto, and the porous particles are necessarily present in water at least when the shell is being formed around the latent heat storage component by interfacial polycondensation of the curable component composition.

The porous particles are not particularly limited, and examples thereof include diatomaceous earth, amorphous wet silica, amorphous dry silica, calcium silicate-type porous material, magnesium aluminometasilicate, and the like. Out of these, amorphous wet silica, amorphous dry silica, calcium silicate-type porous material, and magnesium aluminometasilicate are suitable due to their strength and an oil absorption of 100 mL/100 g or more. Each of these porous particles may be used alone, or two or more of these may be used together.

Here, in the present description, an oil absorption means a value measured in conformity to JIS K 6220; the higher oil absorption means the larger amount of supported aliphatic hydrocarbon as a latent heat-type heat storage component by absorption and adsorption.

The preferable lower limit of an average particle diameter of the porous particles (secondary particles) is 1 μm, and the preferable upper limit is 100 μm.

The average particle diameter of less than 1 μm may make a powder hard to handle; and upon forming the particles into a latent heat storage body, the average particle diameter of more than 100 μm may cause a rough surface, and may result in reduction in dynamical strength of a molding beginning at the resin-coated latent heat storage particles. The more preferable upper limit is 70 μm and the further preferable upper limit is 40 μm.

Two or more kinds of porous particles each comprising a different average particle diameter can be used together upon using the porous particles. Combination of two or more kinds of porous particles each comprising a different average particle diameter makes it possible to improve latent heat storage efficiency, that is, a latent heat storage amount and a heat-absorbing and heat-releasing rate.

With respect to a blending amount of the porous particles, the preferable lower limit is 27 parts by weight and the preferable upper limit is 70 parts by weight to 100 parts by weight of the latent heat storage component. The amount of less than 27 parts by weight may cause difficulty in dispersing porous particles in water to fail to form a particle shape; the amount of more than 70 parts by weight may cause an insufficient latent heat storage effect of resin-coated latent heat storage particles to be obtained. The more preferable lower limit is 33 parts by weight, and the more preferable upper limit is 67 parts by weight.

The isocyanate, the isocyanate and the polyfunctional alcohol, the modified silicone resin and the tin catalyst, or the epoxy resin and the amine compound is/are used as the curable component which is cured by the trigger of water and heat. A substance cured at a relatively low temperature is preferable among these. Using such a curing component can eliminate the necessity for heating at high temperatures in the step of forming a shell on the surface of resin-coated latent heat storage particles, so that it is possible to prevent volatilization of the latent heat storage component. Especially, a substance cured by moisture is suitable.

The isocyanate is not particularly limited, and preference is given to polyisocyanate containing at least two isocyanate groups, in which polyurea is generated by reaction with water or amine, and in which a urethane resin is generated by reaction with a polyfunctional alcohol (including polyol).

Examples of the polyisocyanate include various polyisocyanate compounds generally used for producing a urethane resin. Specific examples thereof include: 2,4-tolylene diisocyanate, phenylene diisocyanate, xylene diisocyanate, diphenylmethane diisocyanate (MDI), 1,5-naphthylene diisocyanate, and hydrides of these; a mixture of MDI and triphenylmethane triisocyanate and the like (crude MDI); isophorone diisocyanate; dicyclohexylmethane diisocyanate; ethylene diisocyanate; methylene diisocyanate; propylene diisocyanate; tetramethylene diisocyanate; and the like. Preference is given to MDI and crude MDI from the viewpoints of safety and reactivity.

Examples of the polyfunctional alcohol include various polyether-type polyols, polyester-type polyols, polymer polyols, and the like, which are generally used for producing a urethane resin.

Examples of the polyether-type polyols include a polyether polyol obtained by ring-opening polymerization of one or more alkylene oxides such as propylene oxide, ethylene oxide, and tetrahydrofuran, in the presence of one or more low-molecular-weight active hydrogen compounds comprising two or more active hydrogens (for example, diols such as bisphenol A, ethylene glycol, propylene glycol, butylene glycol, diethylene glycol, triethylene glycol, octyl glycol, dipropylene glycol, and 1,6-hexanediol; triols such as glycerin, and trimethylol propane; and amines such as ethylenediamine, and butylenediamine).

Examples of the polyester-type polyols include: a polymer obtained by dehydration and condensation of a polybasic acid (for example, adipic acid, azelaic acid, sebacic acid, terephthalic acid, isophthalic acid, succinic acid, and the like) and a polyhydric alcohol (for example, bisphenol A, ethylene glycol, 1,2-propylene glycol, 1,4-butanediol, diethylene glycol, 1,6-hexaneglycol, neopentyl glycol, and the like); a polymer of lactone (for example, ε-caprolactone, α-methyl-ε-caprolactone, and the like); a condensate of a hydroxycarbonic acid, the polyhydric alcohol, and the like (for example, castor oil, a reaction product of castor oil and ethylene glycol, and the like).

Examples of the polymer polyols include: a graft polymer of either one of the polyether polyol or the polyester polyol and an ethylenic unsaturated compound such as acrylonitrile, styrene, and methyl (meth)acrylate; 1,2- or 1,4-polybutadiene polyol; and hydrides thereof. These polyols may be used alone, or two or more of these polyols may be used.

A polyurea can be obtained by reaction of the isocyanate and water.

A urethane resin can be obtained by reaction of the isocyanate and the polyfunctional alcohol. Therefore, dispersing the isocyanate and the polyfunctional alcohol in water causes a reaction of the isocyanate and water to generate polyurea, and simultaneously causes a reaction of the isocyanate and the polyfunctional alcohol to generate a urethane resin.

The urethane resin can be obtained by preliminarily mixing the polyisocyanate and the polyfunctional alcohol under stirring condition before blending the latent heat storage component and the porous particles into water, with the ratio (NCO/OH) between an active hydrogen group (OH) in the polyfunctional alcohol and an active isocyanate group (NCO) in the polyisocyanate being from 1.2 to 15, preferably from 1.2 to 10 in the equivalent ratio. Also, the mixing is preferably carried out in a nitrogen-gas stream, and the mixing is performed in the air within 5 minutes. The equivalent ratio in the above-mentioned range makes it possible to obtain a sufficient coating property with no polyfunctional alcohol locally left unreacted. Moreover, the active isocyanate group of the polyisocyanate reacts with water to generate polyurea and reacts with the polyfunctional alcohol to generate a urethane resin.

The modified silicone resin is not particularly limited, and examples thereof include: a resin comprising a hydrolysable silyl group, a main chain of the resin essentially comprising a polyether-type polymer; and the like. A preferred resin is a resin in which a main chain comprises a polyoxypropylene polymer.

Out of the modified silicone resins, examples of the commercially available resins include: the trade name “MS polymer” (produced by KANEKA CORP.), such as MS polymer S-203 and S-303; the trade name “Silyl polymer” (produced by KANEKA CORP.), such as Silyl SAT-030, SAT-200, SAT-350, and SAT-400; the trade name “Excestar” (produced by ASAHI GLASS CO., LTD.), such as Excestar ESS-3620, ESS-3430, ESS-2420, and ESS-2410; and the like.

The tin catalyst is not particularly limited, and examples thereof include dibutyltin dilaurate, dibutyltin dimalate, dibutyltin phthalate, tin octylate, and the like. Each of these may be used alone, or two or more of these may be used together.

Generally used epoxy resins can be employed as the epoxy resin, and examples thereof include a bisphenol A-type epoxy resin, a bisphenol F-type epoxy resin, a bisphenol AD-type epoxy resin, a bisphenol S-type epoxy resin, a phenolic novolac-type epoxy resin, 3,4-epoxycyclohexylmethyl-3,4-epoxycyclohexanecarboxylate, diglycidyl ether of 1,4-butanediol, diglycidyl phthalate, triglycidyl isocyanurate, and the like.

The amine compound can be used as a curing agent for the epoxy resin.

The amine compound is not particularly limited, and specific examples thereof include: chain aliphatic amines such as ethylenediamine, diethylenetriamine, and polyoxypropylenetriamine, and derivatives thereof; menthene diamine; isophorone diamine; diaminodicyclohexylmethane; and the like.

In addition to the above-mentioned amine compounds, conventional curing agents for various epoxy resins can be used as the curing agent for the epoxy resin. Specific examples thereof include: a compound such as a polyaminoamide compound formed by an amine compound; a hydrazide compound; dicyanamide and derivatives thereof; a melamine compound; and the like.

In order to impart heat resistance and flexibility after curing, it may be also acceptable to add a special epoxy resin such as diglycidyl ether of polyethylene glycol and polypropylene glycol, glycidyl ester of higher fatty acids, and glycidylamine-type epoxy.

With respect to an amount of: isocyanate; isocyanate and a polyfunctional alcohol; a modified silicone resin; or an epoxy resin, as the curable component, the preferable lower limit is 15 parts by weight and the preferable upper limit is 83 parts by weight to 100 parts by weight of the latent heat storage component. The amount of less than 15 parts by weight may cause insufficiency of anti-volatility of the latent heat storage component, and the amount of more than 83 parts by weight may cause difficulty in forming a shell.

In the method of producing resin-coated latent heat storage particles of the present invention, the layered silicate is preferably further added. The layered silicate thus added is uniformly dispersed in the resin shell, and simultaneously locally dispersed near the inner face of the resin shell in the latent heat storage component. Such dispersion can increase a barrier property to the latent heat storage component enclosed therein, and can greatly improve anti-volatility of the latent heat storage component.

Examples of the layered silicate include: smectite-type clay minerals such as montmorillonite, bentonite, saponite, hectorite, beidellite, stevensite, nontronite; vermiculite; halloysite; swelling mica; and the like. Out of these, at least one of montmorillonite, bentonite, and swelling mica can be suitably used. These layered silicates may be a natural product or a synthetic product. Furthermore, each of these layered silicates may be used alone, or two or more of these may be used together. Here, the layered silicate used in the resin-coated latent heat storage particles of the present invention means silicate minerals comprising exchangeable metal cations between the layers.

As the layered silicate, it is preferable to use smectite-type clay minerals and swelling mica, which have a large shape anisotropy defined by the following equation (1). Using a layered silicate which has a large shape anisotropy makes it possible to form a shell which has more excellent strength.

Shape anisotropy=area of crystalline surface (A)/area of crystalline side face (B) (1)

In the equation, the crystalline surface (A) means a surface of the shell, and the crystalline side face (B) means a side face of the shell.

The shape of the layered silicate is not particularly limited, and preferably, an average length is from 0.01 to 3 μm, a thickness is from 0.001 to 1 μm, and an aspect ratio is from 20 to 500; more preferably, an average length is from 0.05 to 2 μm, a thickness is from 0.01 to 0.5 μm, and an aspect ratio is from 50 to 200.

Exchangeable metal cations between the crystalline layers of the layered silicate are metal ions such as a sodium ion and a calcium ion on the crystalline surface of the layered silicate. Since these metal ions have cation exchangeability with other cationic substances, various cationic substances can be intercalated or supplied between the crystalline layers of the layered silicate.

The cation exchange capacity of the layered silicate is not particularly limited, and is preferably from 50 to 200 milliequivalents/100 g. The cation exchange capacity of the layered silicate of less than 50 millieqivalents/100 g causes reduction in an amount of cationic substances intercalated or supplied between the crystalline layers of the layered silicate by cation exchange, which may result in failure to achieve sufficient non-polarization (hydrophobilization) between the crystalline layers; on the contrary, the cation exchange capacity of the layered silicate of more than 200 milliequivalents/100 g causes too strong bond strength between the crystalline layers of the layered silicate, which may result in difficulty in releasing thin crystalline flakes.

In the method of producing resin-coated latent heat storage particles of the present invention, the layered silicate is preferably dispersed as uniformly as possible in the resin shell and near the inner face of the resin shell in the latent heat storage component. In order to achieve such a uniform dispersion of the layered silicate, it is preferable to preliminarily achieve non-polarization between the crystalline layers of the layered silicate by cation exchange using a cationic surfactant. The preliminary non-polarization between the crystalline layers of the layered silicate makes it possible to more uniformly disperse the layered silicate in the resin shell and near the inner face of the resin shell in the latent heat storage component.

The cationic surfactant is not particularly limited, and examples thereof include quaternary ammonium salts, quaternary phosphonium salts, and the like; out of these, quaternary ammonium salts comprising one or more alkyl chains, the carbon number of which is six or more (alkyl ammonium salts the carbon number of which is six or more), can be suitably used, because sufficient non-polarization between the crystalline layers of the layered silicate can be achieved. Each of these cationic surfactants may be used alone, or two or more of these may be used together.

Dispersibility of the layered silicate in the resin shell and the latent heat storage component can be improved by the above-mentioned chemical treatment.

The chemical treatment of the layered silicate is not limited to a cation exchange method by the use of the cationic surfactant, and can be carried out by using various chemical treatment methods. Each of these chemical modification methods may be used alone, or two or more of these may be used together. Here, the layered silicate which has the dispersibility in the resin shell improved by various chemical treatment methods, including the chemical modification method, is also referred to as an “organized layered silicate”.

In the resin shell of resin-coated latent heat storage particles to be obtained, a part or the whole of the layered silicate is preferably dispersed in 10 or less layers.

That a part or the whole of the layered silicate is dispersed in 10 or less layers means that a part or the whole of the layered molecules of the layered silicate which is originally a layered body comprising several tens of layers are peeled off and widely dispersed. Interaction between the crystalline-flake layers of the layered silicate is therefore weakened, and the same effect mentioned above is obtainable. Moreover, the number of layers of the layered silicate is preferably five layers or less, and more preferably three layers or less. Furthermore, the layered silicate is preferably dispersed in a single-layer state (a flake state).

That a part or the whole of the layered silicate is dispersed in 10 or less layers specifically indicates that the layered silicate is preferably in a state that 10% or more of an aggregate of the layered silicates is dispersed in 10 or less layers, and more preferably in a state that 20% or more of the aggregate of the layered silicates is dispersed in 10 or less layers.

Here, a dispersion state of the layered silicate can be calculated by the following steps: observing the layered silicate at a magnification of 50,000 to 100,000 with a transmission electron microscope; counting the number of layered aggregates dispersed in 10 or less layers (Y) among the number of layered aggregates of the layered silicates observed in a predetermined area (X); and then calculating the following equation (2).

Percentage of layered silicate dispersed in 10 or less layers (%)=(Y/X)×100 (2)

An average distance between layers of (001) plane of the layered silicate in the resin shell measured by a wide-angle X-ray diffractometry is preferably 3 nm or more.

Here, the average distance between layers of the layered silicate used herein refers to an average distance between layers in the case that fine crystalline flakes of the layered silicate are regarded as layers, and can be measured by X-ray diffraction peak and photographing with a transmission electron microscope, that is, a wide-angle X-ray diffractometry.

Moreover, the average distance between layers is preferably 6 nm or more. The average distance between crystalline-flake layers of the layered silicate of 6 nm or more causes each crystalline-flake layer to be isolated from one another to weaken interaction between the crystalline-flake layers of the layered silicate to a negligible extent, so that the layered silicate is advantageously dispersed in the resin shell in a state that the crystalline flakes forming the layered silicate are disintegrated to be stable.

With respect to a blending amount of the layered silicate, the preferable lower limit is 0.1 parts by weight and the preferable upper limit is 10 parts by weight to 100 parts by weight of the latent heat storage component. The blending amount of less than 0.1 parts by weight may cause insufficient anti-volatility of the latent heat storage component, and the blending amount of more than 10 parts by weight may cause difficulty in forming a shell.

In the method of producing resin-coated latent heat storage particles of the present invention, the latent heat storage component, the curable component, and the porous particles are dispersed in water under stirring condition. Thus, a particle shape is formed, and simultaneously the resin shell is formed, so that it is possible to prepare a suspension of resin-coated latent heat storage particles.

Isocyanate; isocyanate and a polyfunctional alcohol; a modified silicone resin and a tin catalyst; or an epoxy resin and an amine compound, as the curable component, is/are reacted by the trigger of water and heat, so that the resin shell is formed around the latent heat storage component. The shell thus formed is to have strength such that agglomeration and breaking of the particles do not occur within a very short time.

This is presumably caused by interfacial polycondensation of isocyanate and the like and water, for example, in the case that the curable component is isocyanate.

In the method of producing resin-coated latent heat storage particles of the present invention, the latent heat storage component and the like and the porous particles are simultaneously dispersed in water under stirring condition to form the shell around the latent heat storage component by interfacial polycondensation of the curable component composition; concurrently, the porous particles surround the shell. Therefore, it is possible to obtain monodispersed resin-coated latent heat storage particles which have a suitable size and strength so high as to achieve some degree of stress resistance within a very short time without agglomeration between the resin-coated latent heat storage particles. That is, even in the case that the resin shell is uncured, the resin-coated latent heat storage particles do not agglomerate one other, so that the resin-coated latent heat storage particles can be taken out within a very short time after dispersion under stirring condition to be supplied to the next step.

In the method of producing resin-coated latent heat storage particles of the present invention, the layered silicate is preferably further added, as well as the latent heat storage component, the curable component, and the porous particles.

In the resin-coated latent heat storage particles to be obtained, the layered silicate is uniformly dispersed in the resin shell and near the inner face of the resin shell in the latent heat storage component. Such dispersion of the layered silicate can increase a barrier property of the obtainable resin-coated latent heat storage particles to the latent heat storage component enclosed therein by a baffle effect of the layered silicate, so that anti-volatility of the latent heat storage component can be greatly improved. Therefore, the shell can be thinned, so that it is possible to obtain the resin-coated latent heat storage particles which have a high heat property without reducing a relative content of the latent heat storage component. Moreover, since strength of the resin shell increases, the risk of destruction of the resin shell by an external force can be reduced and anti-volatility of the latent heat storage component can be kept stable for a long period.

In the present description, the resin shell refers to a resin shell in which the layered silicate is uniformly dispersed in the case of adding the layered silicate upon preparing the suspension.

The porous particles are present on the surface of the resin shell. The porous particles thus present on the surface presumably prevent agglomeration of the obtainable resin-coated latent heat storage particles and can increase strength.

A suspension in which water is used as a medium makes it possible to carry out the below-described curing reaction of the curable component at normal temperature or at a comparatively low temperature, and to inhibit volatilization of the latent heat storage component in the curing reaction. Here, since the curing reaction proceeds in the presence of water, such a method is especially suitable in the case of using a moisture-curable component such as isocyanate, isocyanate and a polyfunctional alcohol, and a modified silicone resin and a tin catalyst, as the curable component.

In the method of producing resin-coated latent heat storage particles of the present invention, upon preparing the suspension, the porous particles are preferably added to water at least before adding the latent heat storage component or the curable component. Specifically, for example, the latent heat storage component, the curable component, and the porous particles may be added to water at the same time, or the porous particles may be initially added to water, and then the latent heat storage component and the curable component may be added. Also, subsequent to the porous particles and the latent heat storage component are mixed and water is added thereto, the curable resin may be added. This is because adding each of the materials in such an order makes it possible to effectively prevent agglomeration of the resin-coated latent heat storage particles to be obtained.

In the method of producing resin-coated latent heat storage particles of the present invention, upon preparing the suspension, it may be acceptable to employ, for example, a method comprising the steps of: mixing the porous particles and the latent heat storage component at a temperature not less than a melting point of the latent heat storage component to prepare a latent heat storage composition; mixing the resulting latent heat storage composition and the curable resin, and then adding water to the obtained mixture to prepare a suspension; heating the obtained suspension to cure the curable resin composition; and cooling the suspension.

Each of the steps may be preformed separately in a batch method, but it is preferable to continuously carry out the steps. Productivity is greatly increased by continuously conducting the steps.

In the method of producing resin-coated latent heat storage particles of the present invention, upon adding the layered silicate, it is preferable to preliminarily add the layered silicate to the latent heat storage component or the curable component, then sufficiently stir and disperse the mixture, and thereafter disperse these substances in water under stirring condition. Addition of each material in such an order makes it possible to uniformly disperse the layered silicate in the resin shell and near the inner face of the resin shell in the latent heat storage component, in the resin-coated latent heat storage particles to be obtained.

Especially, it is more preferable to prepare a suspension by preliminarily adding the layered silicate to the latent heat storage component to obtain a composition, and then adding the porous particles, the curable component, and water to the composition and mixing the mixture.

A dispersion state of the layered silicate in the resin shell and the latent heat storage component can be checked by observing a cut face with a transmission electron microscope (TEM).

The method of dispersing the layered silicate in the latent heat storage component is not particularly limited. For example, the layered silicate and the latent heat storage component are kneaded with a twin-screw kneading extruder to prepare what is called a high-concentration masterbatch so that a concentration of the layered silicate is set in the range from 30 to 60% by weight. The latent heat storage component is added to the obtained high-concentration masterbatch and then uniformly mixed with a homodisper so that the final concentration of the layered silicate is adjusted in the range from 0.1 to 10% by weight with respect to the total amount of the layered silicate and the latent heat storage component. Thereafter, the layered silicate can be perfectly dispersed in the latent heat storage component by circulating the mixture with a dispersing rotor (a generator) for emulsification and suspension.

In the method of dispersing the layered silicate in the latent heat storage component, 0.01 to 1 parts by weight of a polar solvent may be added with respect to 100 parts by weight of the latent heat storage component if necessary.

The polar solvent is not particularly limited, and examples thereof include propylene carbonate, methanol, ethanol, α-olefin, and the like. Preference is given to propylene carbonate from the viewpoints of volatility, reactivity, and the like.

In the method of producing resin-coated latent heat storage particles of the present invention, in the case of further adding the layered silicate upon preparing the suspension, it may be acceptable to employ, for example, a method comprising the steps of: mixing the porous particles and the latent heat storage component at a temperature not less than a melting point of the latent heat storage component to prepare a latent heat storage composition; mixing the curable resin and the layered silicate to prepare a curable resin composition in which the layered silicate is uniformly dispersed in the curable resin; mixing the obtained latent heat storage composition and the obtained curable resin composition, and then adding water to the obtained mixture to prepare a suspension; heating the obtained suspension to cure the curable resin composition; and cooling the suspension.

Each of the steps may be performed separately in a batch method, but it is preferable to continuously carry out the steps. Productivity is greatly increased by continuously conducting the steps.

One specific example of the method of preparing the suspension is a method in which a dispersing rotor (a generator) for emulsification and suspension is provided at the last stage on the basis of a particle-mixing and continuous-wetting apparatus represented by MHD series (produced by IKA Japan K.K.). This apparatus comprises multistage dispersing rotors (generators), and for example, the porous particles and the latent heat storage component are charged from the upper stage, and then, the curable component composition is supplied at the next stage; simultaneously or at the last stage, water is charged to finally prepare a suspension. Since dispersion, mixing, and suspension can be thus carried out at the same time, an efficient process suited to large-scale production can be achieved at a low cost.

Moreover, in the case of further adding the layered silicate upon preparing the suspension, the porous particles, the latent heat storage component, and the layered silicate, for example, are charged from the upper stage, and then, a curable component composition is supplied at the next stage; simultaneously or at the last stage, water is charged to finally prepare a suspension.

In the method of producing resin-coated latent heat storage particles of the present invention, heating may be carried out in order to form a shell. A heating temperature may be selected depending on the kind and the like of the curable component. Also, in the case of using, for example, isocyanate and the like as the curable component, a gas (carbon dioxide) may be generated in the curing reaction to notably increase the capacity of the suspension, but the curing reaction is accelerated by heating to finish generation of carbon dioxide in a short time, so that it is possible to minimize the increase in capacity.

By curing the curable component, the shell which coats the latent heat storage component is formed, so that resin-coated latent heat storage particles comprising the resin shell can be obtained.

Forming the resin shell makes it possible to inhibit volatilization of the latent heat storage component, and the resin-coated latent heat storage particles to be obtained can exert a high latent heat storage property.

In the method of producing resin-coated latent heat storage particles of the present invention, it is preferable to immediately cool the suspension after curing the curable component. Immediate cooling of the suspension after curing the curable component makes it possible to prevent agglomeration of the resin-coated latent heat storage particles to be obtained. A cooling temperature is not particularly limited, but generally, the suspension is cooled to the range of normal temperature.

The resin-coated latent heat storage particles produced by the method of the present invention have a structure which comprise as core the latent heat storage component and as shell a resin.

Thus, by coating the latent heat storage component with the resin shell, it is possible to prevent volatilization of the latent heat storage component and to exert a high latent heat storage property.

Moreover, the shell of the resin-coated latent heat storage particles is coated with the porous particles. Thus, by coating the shell with the porous particles, it is possible to prevent agglomeration of the resin-coated latent heat storage particles, and to increase strength of the resin-coated latent heat storage particles.

It is possible to produce a water-curable-type inorganic material by continuous addition of the resin-coated latent heat storage particles produced by the method of the present invention to a compound for the water-curable-type inorganic material and then mixing the obtained mixture.

The present invention also provides such a method of producing a water-curable-type inorganic material, comprising a first step of producing resin-coated latent heat storage particles by the method of the present invention, and a second step of mixing the resin-coated latent heat storage particles and a compound for a water-curable-type inorganic material, the first and second steps being continuous steps.

In the method of producing resin-coated latent heat storage particles of the present invention, the first and second steps are not separately carried out by a batch method, but are continuously performed. The first step makes it possible to obtain monodispersed resin-coated latent heat storage particles which have a suitable size and strength high enough to withstand stress to some extent within a very short time. It is therefore possible to continuously supply the resin-coated latent heat storage particles produced in the first step to a compound for a water-curable-type inorganic material. Thus, productivity can be increased by continuously conducting each step as described above.

The water-curable-type inorganic material is not particularly limited, and examples thereof include gypsum, cement, concrete, and the like.

The compound for a water-curable-type inorganic material is not particularly limited, and examples thereof include compounds formed by pulverizing, drying, and mixing conventionally known materials, such as limestone, clay, siliceous stone, and iron oxide material, and then firing so as to have a predetermined ratio by a conventionally known method.

The method of mixing the resin-coated latent heat storage particles and the compound for a water-curable-type inorganic material is not particularly limited, and a conventionally known method can be used.

### EFFECTS OF THE INVENTION

According to the present invention, it is possible to provide the method of producing resin-coated latent heat storage particles which can be continuously supplied to a producing step of the water-curable-type inorganic material (gypsum, cement, and the like), with a latent heat storage component in the particles hard to volatilize.

### BEST MODE FOR CARRYING OUT THE INVENTION

The following examples illustrate the present invention in further detail; however, the present invention is not limited to these examples.

### Example 1

### (1) Preparation of Suspension

To 100 parts by weight of a paraffin wax (Cactus Normal Paraffin TS7, produced by JAPAN ENERGY CORP.) as a latent heat storage component were added 50 parts by weight of calcium silicate particles (FLORITE R, oil absorption: 400 mL/100 g, produced by TOKUYAMA Corp.) and 50 parts by weight of diphenylmethane diisocyanate modification (SBU isocyanate 0620, produced by Sumika Bayer Urethane Co., Ltd.), and then stirred for two minutes by using a henschel mixer at the number of revolutions of 2,000 rpm to obtain a mixture. To 200 parts by weight of the obtained mixture was added 400 parts by weight of water at normal temperature (25° C.), and then stirred for 10 minutes by using a homodisper at the number of revolutions of 4,000 rpm to obtain a suspension. Here, the curable component was hardly cured at this step (a curing reaction had been started).

### (2) Heating Treatment

The obtained suspension was heated at 60° C. for 10 minutes under stirring condition by using a homodisper at the number of revolutions of 1,000 rpm to cure the curable component.

### (3) Cooling Treatment and Evaluation of Agglomeration Property of Particles

The suspension after the heating treatment was cooled down to 20° C. for 10 minutes under stirring condition by using a homodisper at the number of revolutions of 1,000 rpm. Thus, a suspension containing resin-coated latent heat storage particles was obtained, with almost all the particles being single particles. The particles were obtained 30 minutes after the onset of production of the particles; the particles further being left at rest for 10 minutes, agglomeration of the particles was not also found when visually observed.

### Example 2

### (1) Preparation of Suspension and Heating Treatment

To 50 parts by weight of silica particles (REOLOSIL QS-10, oil absorption: 250 mL/100 g, produced by TOKUYAMA Corp.) was added 400 parts by weight of water at normal temperature (from 20° C. to 25° C.), and then uniformly stirred. Moreover, 100 parts by weight of a paraffin wax (Cactus Normal Paraffin TS8, produced by JAPAN ENERGY CORP.) as a latent heat storage component and 50 parts by weight of a mixture which contains 92.5% by weight of diphenylmethane diisocyanate modification (SBU isocyanate 0620, produced by Sumika Bayer Urethane Co., Ltd.) and 7.5% by weight of diethylene glycol as a curable component were added five minutes after starting mixing, and then stirred at 60° C. for 10 minutes by using a homodisper at the number of revolutions of 4,000 rpm to obtain a suspension in which the curable component was cured. Here, the curable component was not perfectly cured at this step, but had sufficient strength to keep a particle shape.

### (2) Cooling Treatment

The obtained suspension was cooled down to 20° C. for 10 minutes under stirring condition by using a homodisper at the number of revolutions of 1,000 rpm. Thus, a suspension containing resin-coated latent heat storage particles was obtained, with almost all the particles being single particles. The particles were obtained 20 minutes after the onset of production of the particles; the particles further being left at rest for 10 minutes, agglomeration of the particles was not also found when visually observed.

### Example 3

### (1) Preparation of Suspension

Silica particles (TOKUSIL NP, average particle diameter: 23.7 μm, oil absorption: 250 mL/100 g, produced by TOKUYAMA Corp.) and a paraffin wax (Cactus Normal Paraffin TS7, produced by JAPAN ENERGY CORP.) as a latent heat storage component were mixed by using a continuous powder mixer so as to have a ratio of 50 parts by weight of the silica particles to 100 parts by weight of the paraffin wax, and then a mixture was supplied to a MHD series dispersing rotor (generator) (produced by IKA Japan K.K.) at 37.5 kg/h. The generator had three stages, and water at normal temperature (from 20° C. to 25° C.) was supplied to the upper stage at 100 kg/h. Moreover, diphenylmethane diisocyanate modification (SBU isocyanate 0620, produced by Sumika Bayer Urethane Co., Ltd.) was supplied to the middle stage of the generator at 12.5 kg/h. The generator was revolved at 7,000 rpm. A suspension containing resin-coated latent heat storage particles coated by using a curable component was obtained at the lower stage of the generator. Here, the curable component was hardly cured at this step (a curing reaction had been started).

### (2) Heating Treatment

The obtained suspension containing resin-coated latent heat storage particles was continuously injected into a heating stainless-steel container from the lower portion thereof, with the container heated to 60° C. by a jacket, and then the curable component was cured under stirring condition by using a homodisper at the number of revolutions of 500 rpm. Here, the curable component was not perfectly cured at this step, but had sufficient strength to keep a particle shape. The suspension containing resin-coated latent heat storage particles continuously flows out from the upper portion of the heating stainless-steel container into the lower portion of a cooling stainless-steel container to be used next. The time required for flowing from the lower portion to the upper portion of the heating stainless-steel container, that is, the heating time was 10 minutes.

### (3) Cooling Treatment

The suspension containing the resin-coated latent heat storage particles after the heating treatment was continuously injected into the cooling stainless-steel container from the lower portion thereof, with the cooling stainless-steel container cooled down to 15° C. by a jacket, and then the suspension containing resin-coated latent heat storage particles was cooled down to 20° C. under stirring condition by using a homodisper at the number of revolutions of 500 rpm. Thus, a suspension containing resin-coated latent heat storage particles was obtained, with almost all the particles being single particles. The time required for flowing from the lower portion to the upper portion of the cooling stainless-steel container, that is, the cooling time was 10 minutes. The suspension containing resin-coated latent heat storage particles was obtained from the upper exit of the cooling stainless-steel container at a flow of 150 kg/h.

### Example 4

### (1) Preparation of Suspension

A suspension containing resin-coated latent heat storage particles coated with a curable component was obtained at a flow of 150 kg/h in the same manner as that in Example 3-(1). Here, the curable component was hardly cured at this step (a curing reaction had been started).

### (2) Production of latent Heat Storage Gypsum Board

Calcined gypsum was supplied to the suspension obtained above at a rate of 100 kg/h to prepare a gypsum slurry. The gypsum slurry was poured into a frame which has a size of 910 mm×1,820 mm×12.5 mm, and then dried at 100° C. for an hour to obtain a latent heat storage gypsum board. Here, in resin-coated latent heat storage particles contained in the obtained latent heat storage gypsum board, the curing reaction was finished in the drying treatment to obtain sufficient strength.

### Example 5

### (1) Production of Resin-Coated Latent Heat Storage Particles

To 20 parts by weight of silica particles (TOKUSIL NP, average particle diameter: 23.7 μm, produced by TOKUYAMA Corp.) as porous particles was dropped 50 parts by weight of a paraffin wax (TS7, produced by JAPAN ENERGY CORP.) as a latent heat storage component, followed by stirring for three minutes by using a henschel mixer at the number of revolutions of 2,000 rpm; thus, the latent heat storage component was absorbed and adsorbed in the silica particles to produce resin-coated latent heat storage particles.

### (2) Production of Curable Resin Composition

An amount of 28.6 parts by weight of terminally silylated polypropylene glycol (Kaneka Silyl SAT030, produced by KANEKA CORP.) as a modified silicone resin, 0.9 parts by weight of [3-(2-aminoethyl)aminopropyl]trimethoxysilane (KBM-603, produced by Shin-Etsu Chemical Co., Ltd.) as a methoxysilane compound, and 0.5 parts by weight of dibutyltin dilaurate as a catalyst were mixed for a minute by using a homodisper at the number of revolutions of 500 rpm to prepare a curable resin composition.

### (3) Preparation of Suspension

An amount of 400 parts by weight of water at normal temperature (25° C.) was added to 200 parts by weight of a mixture containing 70 parts by weight of the obtained latent heat storage component and 30 parts by weight of the obtained curable resin composition, followed by stirring for 10 minutes by using a homodisper at the number of revolutions of 4,000 rpm to obtain a suspension containing resin-coated latent heat storage particles coated with the curable component. Here, the curable component was hardly cured at this step (a curing reaction had been started).

### Example 6

### (1) Preparation of Suspension

To 100 parts by weight of calcium silicate particles (FLORITE R, produced by TOKUYAMA Corp.) as porous particles was dropped 200 parts by weight of a paraffin wax (Cactus Normal Paraffin TS7, produced by JAPAN ENERGY CORP.) as a latent heat storage component with a temperature kept at 45° C., and then stirred for two minutes by using a henschel mixer at the number of revolutions of 2,000 rpm to obtain a powder composition A in which the paraffin wax was adsorbed in silica particles.

Next, 30 parts by weight of a layered silicate (Cloisite 30B, produced by Southern Clay Products, Inc.) was added to 100 parts by weight of diethylene glycol (produced by Maruzen Petrochemical Co., Ltd.), and then stirred for 120 minutes by using a homogenizer at the number of revolutions of 6,000 rpm, to prepare a layered-silicate dispersion. With 100 parts by weight of diphenylmethane diisocyanate modification (SBU isocyanate 0620, produced by Sumika Bayer Urethane Co., Ltd.) was mixed 10 parts by weight of the obtained layered-silicate dispersion under a nitrogen-gas stream to obtain a composition B in which the layered silicate was dispersed in an uncured curable component.

To 300 parts by weight of the obtained powder composition A was added 90 parts by weight of the composition B, and then stirred for two minutes by using a henschel mixer at the number of revolutions of 400 rpm to obtain a mixture. To 390 parts by weight of the obtained mixture was added 780 parts by weight of water at normal temperature (from 20° C. to 25° C.), and then stirred for 10 minutes by using a homodisper at the number of revolutions of 4,000 rpm to obtain a suspension. Here, the curable component was hardly cured at this step (a curing reaction had been started).

### (2) Heating Treatment

The obtained suspension was heated at 60° C. for 10 minutes under stirring condition by using a homodisper at the number of revolutions of 1,000 rpm to cure the curable component.

### (3) Cooling Treatment

The suspension after heating was cooled down to 20° C. for 10 minutes under stirring condition by using a homodisper at the number of revolutions of 1,000 rpm. Thus, a suspension containing resin-coated latent heat storage particles was obtained, with almost all the particles being single particles.

### Example 7

### (1) Preparation of Suspension

To 100 parts by weight of silica particles (REOLOSIL QS-10, produced by TOKUYAMA Corp.) as porous particles was sprayed 200 parts by weight of a paraffin wax (Cactus Normal Paraffin TS7, produced by JAPAN ENERGY CORP.) as a latent heat storage component with a temperature kept at 45° C. to obtain a powder composition C in which the paraffin wax was adsorbed in the silica particles by using a continuous fluidized granulator (MIXGRAD, produced by OKAWARA MFG. CO., LTD.).

Next, 100 parts by weight of octylene glycol and 30 parts by weight of a layered silicate (S-BEN E, produced by HOJUN Co., Ltd.) were mixed by using a continuous disperser (HOMOMIC LINE FLOW, produced by PRIMIX Corp.) to prepare a layered-silicate dispersion. An amount of 100 parts by weight of diphenylmethane diisocyanate modification (SBU isocyanate 0620, produced by Sumika Bayer Urethane Co., Ltd.) and 10 parts by weight of the obtained layered-silicate dispersion were mixed by using an instantaneous mixer (MHD series, produced by IKA-Werke GmbH & Co. KG.) to obtain a composition D in which the layered silicate was dispersed in an uncured curable component.

To 300 parts by weight of the obtained powder composition C were added 90 parts by weight of the composition D and 780 parts by weight of water at normal temperature (from 20° C. to 25° C.), and then mixed by using a continuous disperser (HOMOMIC LINE FLOW, produced by PRIMIX Corp.) to obtain a suspension.

### (2) Heating Treatment

The obtained suspension was heated to 60° C. in a pipe to cure the curable component.

### (3) Cooling Treatment

The suspension after the heating treatment was cooled down to 20° C. in the pipe.

Thus, a suspension containing resin-coated latent heat storage particles was obtained, with almost all the particles being single particles.

### Example 8

### (1) Preparation of Suspension

An amount of 60 parts by weight of a paraffin wax (Cactus Normal Paraffin TS7, produced by JAPAN ENERGY CORP.) and 40 parts by weight of a layered silicate (S-BEN NX, produced by HOJUN Co., Ltd.) were mixed to produce a high-concentration masterbatch by using a twin-screw kneading extruder.

An amount of 7.5 parts by weight of the obtained high-concentration masterbatch, 92.5 parts by weight of a paraffin wax (Cactus Normal Paraffin TS7, produced by JAPAN ENERGY CORP.), and 0.1 parts by weight of propylene carbonate were mixed to produce a layered-silicate dispersion by using a circulation-type instantaneous mixer (MHD series, produced by IKA-Werke GmbH & Co. KG.).

A powder composition was produced so as to contain 70% by weight of the obtained layered-silicate dispersion and 30% by weight of silica particles (TOKUSIL NP, average particle diameter: 23.7 μm, produced by TOKUYAMA Corp.) by using a continuous powder mixer (SUPERTURBO, produced by NISSHIN ENGINEERING INC.).

An amount of 24% by weight of the obtained powder composition, 10% by weight of diphenylmethane diisocyanate modification (SBU isocyanate 0620, produced by Sumika Bayer Urethane Co., Ltd.), and 66% by weight of water at normal temperature were mixed by using a continuous disperser (HOMOMIC LINE FLOW, produced by PRIMIX Corp.) to obtain a suspension.

### (2) Heating Treatment

The obtained suspension was heated up to 60° C. in a pipe to cure the curable component.

### (3) Cooling Treatment

The suspension after the heating treatment was cooled down to 20° C. in the pipe.

Thus, a suspension containing resin-coated latent heat storage particles was obtained, with almost all the particles being single particles.

### Comparative Example 1

To 300 parts by weight of an ion-exchanged water were mixed 0.08 parts by weight of sodium sulfite as an water-soluble polymerization inhibitor, and 20 parts by weight of a 10%-by-weight water solution of partially-saponified polyvinyl acetate (GM-14, produced by The Nippon Synthetic Chemical Industry Co., Ltd.) as a dispersion stabilizer, and then stirred to prepare a water-based dispersion medium. An amount of 29.1 parts by weight of methyl methacrylate, 0.9 parts by weight of 1,6-hexanediol dimethacrylate, 70 parts by weight of n-hexadecane as a latent heat storage component, and 0.7 parts by weight of t-hexylperoxy-2-ethylhexanoate as a polymerization initiator were mixed, and then stirred to prepare a monomer solution for polymerization. The water-based dispersion medium and the monomer solution for polymerization were mixed, and then suspended and dispersed by using a homogenizer (POLYTRON PT10-35, produced by KINEMATICA GmbH LITTAU) at a stirring speed of 5,000 rpm. An average particle diameter of oil droplets in the obtained suspended dispersion was about 20 μm. Next, the obtained suspended dispersion was charged into a container (polymerization container) provided with a stirrer, a hot-water circulation-type heating device which is equipped around the container, a reflux condenser, and a thermometer, and then the inside of the polymerization container was decompressed to carry out deoxidation in the container, and thereafter, the inside of the container was re-compressed by nitrogen, so that gas in the container was replaced by nitrogen. The polymerization container was heated up to 80° C., and polymerization was started with the rotation of the stirrer.

Polymerization was finished in four hours, and then the polymerization container was cooled down to room temperature for an hour. A slurry (suspension) containing a latent heat storage microcapsule was obtained, with a microcapsule concentration set to about 25% by weight.

### Comparative Example 2

A slurry (suspension) was obtained in the same method as that in Comparative Example 1, except that polymerization was finished in 30 minutes in place of completing polymerization in four hours, and that cooling was not carried out instead of cooling for an hour.

### Comparative Example 3

To 100 parts by weight of a paraffin wax (Cactus Normal Paraffin TS7, produced by JAPAN ENERGY CORP.) as a latent heat storage component was added 50 parts by weight of diphenylmethane diisocyanate modification (SBU isocyanate 0620, produced by Sumika Bayer Urethane Co., Ltd.) as a curable component, and then stirred for two minutes with a henschel mixer at the number of revolutions of 2,000 rpm to obtain a mixture. To 150 parts by weight of the obtained mixture was added 300 parts by weight of water at normal temperature (25° C.), and then stirred for 30 minutes with a homodisper at the number of revolutions of 4,000 rpm. Thereafter, when stirring was stopped, the mixture was attached to a wing and a shaft of the homodisper, so that a suspension was not obtained and the mixture did not become particles. This prevented implementation of the below-mentioned evaluations.

### Comparative Example 4

To 100 parts by weight of a paraffin wax (Cactus Normal Paraffin TS8, produced by JAPAN ENERGY CORP.) as a latent heat storage component was added 50 parts by weight of a mixture containing 92.5% by weight of diphenylmethane diisocyanate modification (SBU isocyanate 0620, produced by Sumika Bayer Urethane Co., Ltd.) and 7.5% by weight of diethylene glycol as a curable component, and then stirred for two minutes with a henschel mixer at the number of revolutions of 2,000 rpm to obtain a mixture. To the mixture was added 300 parts by weight of 0.1% water solution (25° C.) of polyethyleneimine (EPOMIN SP-180, produced by NIPPON SHOKUBAI CO., LTD.) as a dispersant, and then stirred for 30 minutes with a homodisper at the number of revolutions of 4,000 rpm. Thereafter, when stirring was stopped, the mixture was attached to a wing and a shaft of the homodisper, so that a suspension was not obtained and the mixture did not become particles. This prevented implementation of the below-mentioned evaluations.

### Comparative Example 5

To 100 parts by weight of a paraffin wax (Cactus Normal Paraffin TS6, produced by JAPAN ENERGY CORP.) as a latent heat storage component was added 50 parts by weight of diphenylmethane diisocyanate modification (SBU isocyanate 0620, produced by Sumika Bayer Urethane Co., Ltd.) as a curable component, and then stirred for two minutes with a henschel mixer at the number of revolutions of 2,000 rpm to obtain a mixture. To the mixture was added 300 parts by weight of 1% water solution (25° C.) of carboxymethyl cellulose (F100MC, produced by NIPPON PAPER CHEMICALS CO., LTD.) as a dispersant, and then stirred for 30 minutes with a homodisper at the number of revolutions of 4,000 rpm. Thereafter, when stirring was stopped, the mixture was attached to a wing and a shaft of the homodisper, so that a suspension was not obtained and the mixture did not become particles. This prevented implementation of the below-mentioned evaluations.

In Comparative Examples 3 to 5, since porous particles were not used as a dispersant, particles were not able to be obtained, which prevented implementation of the below-mentioned evaluations.

### (Evaluation)

With respect to the resin-coated latent heat storage particles or the latent heat storage microcapsules produced in each of Examples 1 to 8 and Comparative Examples 1 and 2, evaluations were made by the following method.

Tables 1 and 2 show the results.

### (1) Measurement of Time for Producing Suspension

In each of Examples 1, 2, and 6, the time required for: the primary stirring started after finishing addition of the porous particles, the latent heat storage component, the curable component, and water; the heating treatment; and the cooling treatment was regarded as a time for producing a suspension.

In each of Examples 3, 7, and 8, the time necessary for the heating treatment and the cooling treatment was defined as a time for producing a suspension.

In Example 4, the heating treatment and the cooling treatment were not carried out and the latent heat storage gypsum board was produced, so that a time for producing a suspension was considered as 0 minutes.

In Example 5, the suspension was produced without the heating treatment and the cooling treatment, so that a time for producing a suspension was interpreted as 10 minutes.

In Comparative Example 1, the time from the onset of polymerization to the end of the cooling treatment was viewed as a time for producing a suspension to be measured.

In Comparative Example 2, the time from a starting point of polymerization to a point when 30 minutes passed was looked on as a time for producing a suspension. At this time, a suspension was observed by means of a microscope and it was found that particles were not formed therein.

Here, in each of Examples 1 to 8 and Comparative Example 1, subsequent to the time for producing a suspension passed, the resin-coated latent heat storage particles did not agglomerate one another, and the average particle diameter was not changed.

### (2) Measurement of Average Particle Diameter

With respect to resin-coated latent heat storage particles obtained in each of Examples 1 to 8 and Comparative Examples 1 and 2, a volume-average particle diameter was measured as the average particle diameter by a laser diffraction method with a scattering particle size distribution analyzer (LA-910, produced by HORIBA, Ltd.).

### (3) Measurement of Melting Point, Latent Heat Storage Amount, and Wax Retention

The resin-coated latent heat storage particles in the suspension obtained in each of Examples 1 to 3 and 5 to 8 were dried at normal temperature and normal pressure, and dried resin-coated latent heat storage particles comprising a moisture content of 2% or less were used as measurement samples 1 to 3 and measurement samples 5 to 8. The latent heat storage gypsum board obtained in Example 4 was broken and pulverized to be used as a measurement sample 4.

The latent heat storage microcapsule in the suspension obtained in Comparative Example 1 was vacuum-dried at 80° C. for two hours, and dried resin-coated latent heat storage particles comprising a moisture content of 2% or less was employed as a measurement sample 9.

A melting point and a latent heat storage amount of each of the measurement samples were measured as shown in FIG. 1 by virtue of a differential scanning calorimeter (DSC6200, produced by Seiko Instruments Inc.).

A wax retention of each of the measurement samples 1 to 3 and 5 to 8 was calculated by the following equation (1).

A wax retention of the measurement sample 4 was calculated by the following equation (2).

$$\begin{matrix}[ Equation 1 ] & \\ Wax retention ( \% ) = \frac{\{ \begin{matrix}Heat \text{-} storage amount of \\ measurement sample ( J \text{/} g )\end{matrix} \} \times 100}{\begin{matrix}\{ \begin{matrix}Heat \text{-} storage amount of \\ heat \text{-} storage component ( J \text{/} g ) \end{matrix} \} \times \\ ( \begin{matrix}Proportion of heat \text{-} storage component \\ in resin \text{-} coated heat \text{-} storage particles\end{matrix} )\end{matrix}} & ( 1 ) \\ [ Equation 2 ] & \\ Wax retention ( \% ) = \frac{[ \begin{matrix}Heat \text{-} storage amount of \\ measurement sample ( J \text{/} g )\end{matrix} ] \times 100}{\begin{matrix}[ \begin{matrix}Heat \text{-} storage amount of \\ heat \text{-} storage component ( J \text{/} g ) \end{matrix} ] \times \\ ( \begin{matrix}Proportion of heat \text{-} storage component \\ in resin \text{-} coated heat \text{-} storage particles\end{matrix} ) \times \\ ( \begin{matrix}Proportion of resin \text{-} coated \\ heat \text{-} storage particles in \\ heat \text{-} storage gypsum board\end{matrix} )\end{matrix}} & ( 2 )\end{matrix}$$

(4) Measurement of n-Heptadecane Concentration

With respect to the resin-coated latent heat storage particles obtained in Examples 1, 3, and 6 to 8, a calibration curve was formed, regarding an n-heptadecane reagent (produced by Wako Pure Chemical Industries, Ltd.) as a reference material, by a small chamber method in conformity with JIS A 1901 to calculate an n-heptadecane concentration.

Here, according to the progress report from the committee on sick-house syndrome (indoor air pollution) (Ministry of Health, Labour and Welfare), a guideline value of n-tetradecane is 330 μg/m³. The report does not indicate a guideline value of n-heptadecane, but less than 330 μg/m³ is presumably suitable as a practicable level, referring to the guideline value of n-tetradecane which is the same kind as a normal paraffin.

TABLE 1

| | | | | | | | | | Comparative | Comparative |
|---|---|---|---|---|---|---|---|---|---|---|
| | Example 1 | Example 2 | Example 3 | Example 4 | Example 5 | Example 6 | Example 7 | Example 8 | Example 1 | Example 2 |
| Time for | 30 | 20 | 20 | 0 | 10 | 30 | 40 | 40 | 300 | 30 |
| producing | | | | | | | | | | |
| suspension | | | | | | | | | | |
| (minute) | | | | | | | | | | |
| Average | 18 | 40 | 8 | 8 | 15 | 40 | 38 | 18 | 25 | — |
| particle | | | | | | | | | | |
| diameter | | | | | | | | | | |
| (μm) | | | | | | | | | | |
| Melting | 17.6 | 23.7 | 17.6 | 12.1 | 17.6 | 17.6 | 17.6 | 17.6 | 13.3 | — |
| point | | | | | | | | | | |
| (° C.) | | | | | | | | | | |
| Amount of | 70 | 99 | 99 | 32 | 70 | 70 | 70 | 70 | 150 | — |
| heat storage | | | | | | | | | | |
| (J/g) | | | | | | | | | | |
| Wax | 98 | 99 | 96 | 93 | 97 | 99 | 99 | 99 | 98 | — |
| retention | | | | | | | | | | |
| (%) | | | | | | | | | | |

TABLE 2

| | n-heptadecane |
|---|---|
| | concentration |
| | (μg/m³) |
| Example 1 | 850 |
| Example 3 | 850 |
| Example 6 | 300 |
| Example 7 | 280 |
| Example 8 | 220 |

Table 1 shows that, in Examples 1 to 8 compared with Comparative Examples 1 and 2, resin-coated latent heat storage particles can be produced within a very short time, and that it is possible to continuously produce a gypsum board.

### INDUSTRIAL APPLICABILITY

The present invention can provide a method of producing resin-coated latent heat storage particles which can be continuously supplied to a producing step of a water-curable-type inorganic material (gypsum, cement, and the like), with a latent heat storage component in the particles hard to volatilize.

### BRIEF DESCRIPTION OF THE DRAWINGS

FIG. 1 is a schematic view which describes a method for measuring a melting point and a latent heat storage amount with a differential scanning calorimeter.

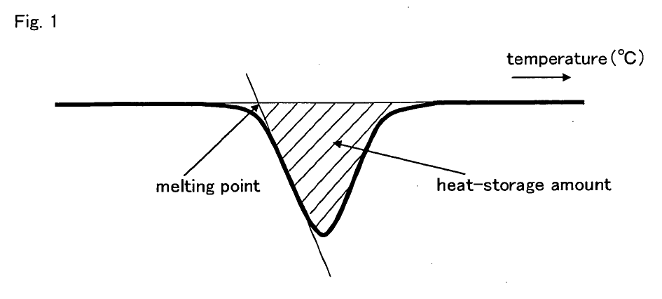

1. A method of producing particles, comprising a step of dispersing a latent heat storage component, isocyanate, and porous particles in water under stirring condition, said particles comprising as core said latent heat storage component and as shell a resin.

2. A method of producing particles, comprising a step of dispersing a latent heat storage component, isocyanate, a polyfunctional alcohol, and porous particles in water under stirring condition,
said particles comprising as core said latent heat storage component and as shell a resin.

3. A method of producing particles, comprising a step of dispersing a latent heat storage component, a modified silicone resin, a tin catalyst, and porous particles in water under stirring condition,
said particles comprising as core said latent heat storage component and as shell a resin.

4. A method of producing particles, comprising a step of dispersing a latent heat storage component, an epoxy resin, an amine compound, and porous particles in water under stirring condition,
said particles comprising as core said latent heat storage component and as shell a resin.

5. The method of producing particles according to claim 1, further comprising a step of adding a layered silicate.

6. A method of producing a water-curable-type inorganic material, comprising a first step of producing latent heat storage particles by the method of producing particles in claim 1, and a second step of mixing said latent heat storage particles and a compound for a water-curable-type inorganic material, said first and second steps being continuous steps.

7. The method of producing particles according to claim 2, further comprising a step of adding a layered silicate.

8. The method of producing particles according to claim 3, further comprising a step of adding a layered silicate.

9. The method of producing particles according to claim 4, further comprising a step of adding a layered silicate.

10. A method of producing a water-curable-type inorganic material, comprising a first step of producing latent heat storage particles by the method of producing particles in claim 2, and a second step of mixing said latent heat storage particles and a compound for a water-curable-type inorganic material, said first and second steps being continuous steps.

11. A method of producing a water-curable-type inorganic material, comprising a first step of producing latent heat storage particles by the method of producing particles in claim 3, and a second step of mixing said latent heat storage particles and a compound for a water-curable-type inorganic material, said first and second steps being continuous steps.

12. A method of producing a water-curable-type inorganic material, comprising a first step of producing latent heat storage particles by the method of producing particles in claim 4, and a second step of mixing said latent heat storage particles and a compound for a water-curable-type inorganic material, said first and second steps being continuous steps.

13. A method of producing a water-curable-type inorganic material, comprising a first step of producing latent heat storage particles by the method of producing particles in claim 5, and a second step of mixing said latent heat storage particles and a compound for a water-curable-type inorganic material, said first and second steps being continuous steps.
